(19) United States
(12) Patent Application Publication
(10) Pub. No.: US 2020/0404968 A1
(43) Pub. Date: Dec. 31, 2020

(54) Vapour Generating System

(71) Applicant: JT International S.A., Geneva (CH)

(72) Inventor: Andrew Robert John Rogan, Forres (GB)

(73) Assignee: JT International S.A., Geneva (CH)

(21) Appl. No.: 16/978,300

(22) PCT Filed: Apr. 25, 2019
(86) PCT No.: PCT/EP2019/060564

§ 371 Date: Sep. 4, 2020

(30) Foreign Application Priority Data
Apr. 27, 2018 (EP) 18169766.5

(51) Int. Cl. A24F 40/46; A24F 40/465; A24F 40/485; H05B 6/10

(52) U.S. Cl. CPC A24F 40/46; A24F 40/465; H05B 2203/021; H05B 6/108; A24F 40/485

(57) ABSTRACT

A vapour generating system includes a vapour generating space for containing a vapour generating material and a heater for heating the vapour generating material to generate a first vapour. The vapour generating system further includes an air inlet, an air outlet, an air flow passage connecting the air inlet and the air outlet via the vapour generating space, an outer surface and a cooling chamber. The cooling chamber includes a liquid which is vaporisable to form a second vapour and the cooling chamber is positioned between the heater and the outer surface and/or between the air flow passage and the outer surface.

### TECHNICAL FIELD

The present disclosure relates generally to a vapour generating system, and more particularly to a vapour generating system for generating a vapour or aerosol for inhalation by a user. Embodiments of the present disclosure also relate to a vapour generating device.

### TECHNICAL BACKGROUND

Devices which heat, rather than burn, a vapour generating material to produce a vapour for inhalation have become popular with consumers in recent years. Such devices can use one of a number of different approaches to provide heat to the vapour generating material.

One approach is to provide a vapour generating device which employs a resistive heating system. In such a device, a resistive heating element is provided to heat the vapour generating material and vapour is generated as the vapour generating material is heated by heat transferred from the heating element.

Another approach is to provide a vapour generating device which employs an induction heating system. In such a device, an induction coil is provided with the device and a susceptor is provided typically with the vapour generating material. Electrical energy is provided to the induction coil when a user activates the device which in turn generates an alternating electromagnetic field. The susceptor couples with the electromagnetic field and generates heat which is transferred, for example by conduction, to the vapour generating material and vapour is generated as the vapour generating material is heated.

Whichever approach is used to heat the vapour generating material, there is a need to control the level of heat within the vapour generating device and the present disclosure seeks to address this need.

### SUMMARY OF THE DISCLOSURE

According to a first aspect of the present disclosure, there is provided a vapour generating system comprising:
a vapour generating space for containing a vapour generating material;
a heater for heating the vapour generating material to generate a first vapour;
an air inlet, an air outlet and an air flow passage connecting the air inlet and the air outlet via the vapour generating space;
an outer surface; and
a cooling chamber comprising a liquid which is vaporisable to form a second vapour;
wherein the cooling chamber is positioned between the heater and the outer surface and/or between the air flow passage and the outer surface.

According to a second aspect of the present disclosure, there is provided a vapour generating device comprising:
a vapour generating space for receiving a vapour generating material;
an induction coil for heating the vapour generating material to generate a first vapour;
an air inlet, an air outlet and an air flow passage connecting the air inlet and the air outlet via the vapour generating space;
an outer surface;
a cooling chamber comprising a liquid which is vaporisable to form a second vapour;
wherein the cooling chamber is positioned between the induction coil and the outer surface and/or between the air flow passage and the outer surface.

According to a third aspect of the present disclosure, there is provided a vapour generating device comprising:
a vapour generating space for receiving a vapour generating material;
a resistive heater for heating the vapour generating material to generate a first vapour;
an air inlet, an air outlet and an air flow passage connecting the air inlet and the air outlet via the vapour generating space;
an outer surface;
a cooling chamber comprising a liquid which is vaporisable to form a second vapour;
wherein the cooling chamber is positioned between the resistive heater and the outer surface and/or between the air flow passage and the outer surface.

The vapour generating system/device is adapted to heat the vapour generating material, without burning the vapour generating material, to volatise at least one component of the vapour generating material and thereby generate a vapour for inhalation by a user of the vapour generating system/device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The cooling chamber provides an effective way to remove heat from the vapour generating system/device and, therefore, to control the level of heat within the system/device because the liquid in the cooling chamber is vaporised in use of the system/device. In particular, the liquid in the cooling chamber evaporates to form the second vapour as it absorbs heat from within the system/device, for example from component parts of the system/device such as the heater and/or from heated vapour flowing through the air flow passage. The heat is transferred from the second vapour to the surrounding ambient air and as the second vapour cools, it condenses back into a liquid so that it can again absorb heat from within the system/device. Because heat is removed from the vapour generating system/device in a controlled and uniform manner by the second vapour in the cooling chamber, hot and cold regions at the outer surface are avoided and user comfort is improved when handling the system/device due to a uniform temperature at the outer surface.

The cooling chamber is a sealed cooling chamber and the liquid is vaporisable inside the cooling chamber to form a second vapour. The liquid in the cooling chamber, both in its liquid and vapour form, is locked in the cooling chamber. The cooling chamber is, therefore, a sealed component and provides for reliable cooling of the system/device.

The cooling chamber may comprise a wick to transfer the liquid from a first position in the cooling chamber to a second position in the cooling chamber. The wick helps to control the movement of the liquid in the cooling chamber and, therefore, optimises heat transfer and cooling of the system/device.

The first position in the cooling chamber may be closer to the outer surface than the second position in the cooling chamber. Thus, the liquid may be transferred by the wick from the first position, closer to the outer surface, to the second position which is typically positioned closer to the source(s) of heat within the system/device, for example the heater and/or the air flow passage. This ensures that the cooling chamber can function in an optimum manner and provide optimum cooling of the system/device.

The liquid in the cooling chamber may have a boiling point less than approximately 60° C. The boiling point may be less than approximately 50° C. The boiling point may be less than approximately 40° C. The temperature of the outer surface is affected by the temperature of the second vapour in the cooling chamber and the temperature of the outer surface can be maintained at a more comfortable level for a user if the boiling point of the liquid is as defined above. The liquid may comprise water or ethyl-alcohol. The liquid is ideally selected so that it does not cause any degradation of the wick.

The wick may comprise a mesh structure.

The heater may comprise a resistive heater. The resistive heater may comprise a resistive heating element.

The heater may comprise an induction heatable susceptor and the vapour generating system may comprise an induction coil arranged to generate an alternating electromagnetic field for inductively heating the induction heatable susceptor. The cooling chamber may be positioned between the induction coil and the outer surface. This arrangement provides a particularly convenient way to heat the vapour generating material using induction heating. The cooling chamber provides for effective removal of heat generated within the device due to the operation of the induction coil.

The induction coil may comprise a Litz wire or a Litz cable. It will, however, be understood that other materials could be used. The induction coil may be substantially helical in shape and may extend around the vapour generating space.

The circular cross-section of a helical induction coil may facilitate the insertion of vapour generating material, or for example a vapour generating article containing the vapour generating material and optionally one or more of said induction heatable susceptors, into the vapour generating space and ensures uniform heating of the vapour generating material.

The induction heatable susceptor may comprise one or more, but not limited, of aluminium, iron, nickel, stainless steel and alloys thereof, e.g. Nickel Chromium or Nickel Copper. With the application of an electromagnetic field in its vicinity, the susceptor may generate heat due to eddy currents and magnetic hysteresis losses resulting in a conversion of energy from electromagnetic to heat.

The induction coil may be arranged to operate in use with a fluctuating electromagnetic field having a magnetic flux density of between approximately 20 mT and approximately 2.0 T at the point of highest concentration.

The vapour generating system/device may include a power source and circuitry which may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The wick may include an electrically conductive material and may be arranged to provide an electromagnetic shield for the induction coil. The provision of an electromagnetic shield advantageously helps to reduce leakage of the electromagnetic field generated by the induction coil. Because the wick acts as the electromagnetic shield, a separate shield is not needed thereby reducing component count and simplifying the fabrication/structure of the system/device and leading to the provision of a more compact system/device.

The wick may comprise a metal. Examples of suitable metals include, but are not limited to, aluminium and copper.

The wick may extend substantially across at least one side of the induction coil. The wick effectively moves the liquid. Further, if the wick comprises a metal and the system/device operates based on the induction heating principle, the shielding effect is thereby maximised.

The system/device may further comprise a ferrimagnetic, non-electrically conductive material positioned between the wick and the induction coil. The ferrimagnetic, non-electrically conductive material may extend substantially across at least one side of the induction coil. Examples of suitable ferrimagnetic, non-electrically conductive materials include, but are not limited to, ferrite, Nickel Zinc Ferrite and mu-metal. The ferrimagnetic, non-electrically conductive material further contributes to the electromagnetic shielding properties and in combination with the electrically conductive material of the wick provides a particularly effective electromagnetic shield for the induction coil.

The air flow passage may be positioned between the induction coil and the outer surface. This arrangement may assist with heat transfer from the induction coil and, thus, may assist with cooling of the induction coil.

The cooling chamber may comprise an inner wall proximate the induction coil and the inner wall may include a metal. The inner wall advantageously comprises a metal having good heat conductivity and electromagnetic shielding properties. An example of a suitable metal is copper. The metallic inner wall is capable of absorbing heat from the induction coil and thus assists with heat transfer from the induction coil and, hence, cooling of the induction coil. The metallic inner wall may also act as an electromagnetic shield for the induction coil and, thus, help to reduce electromagnetic leakage.

The cooling chamber may be positioned between the outer surface and a portion of the air flow passage connecting the vapour generating space to the air outlet. Heat from the first vapour flowing through the air flow passage is transferred to the cooling chamber thus assisting with the cooling of the heated first vapour as it flows through the air flow passage.

The vapour generating material may be any type of solid or semi-solid material. Example types of vapour generating solids include powder, granules, pellets, shreds, strands, particles, gel, strips, loose leaves, cut filler, porous material, foam material or sheets. The vapour generating material may comprise plant derived material and in particular, may comprise tobacco.

The vapour generating material may comprise an aerosol-former. Examples of aerosol-formers include polyhydric alcohols and mixtures thereof such as glycerine or propylene glycol. Typically, the vapour generating material may comprise an aerosol-former content of between approximately 5% and approximately 50% on a dry weight basis. In some embodiments, the vapour generating material may comprise an aerosol-former content of approximately 15% on a dry weight basis.

The vapour generating article may comprise an air-permeable shell containing vapour generating material. The air permeable shell may comprise an air permeable material which is electrically insulating and non-magnetic. The material may have a high air permeability to allow air to flow through the material with a resistance to high temperatures. Examples of suitable air permeable materials include cellulose fibres, paper, cotton and silk. The air permeable material may also act as a filter. Alternatively, the vapour generating article may comprise a vapour generating substance wrapped in paper. Alternatively, the vapour generating material may be contained inside a material that is not air permeable, but which comprises appropriate perforations or openings to allow air flow. The vapour generating material may be formed substantially in the shape of a stick.

### BRIEF DESCRIPTION OF THE DRAWINGS

FIG. 1 is a diagrammatic exploded view of part of a vapour generating system according to a first embodiment of the present disclosure;

FIG. 2 is a diagrammatic assembled view of the vapour generating system illustrated in FIG. 1;

FIG. 3 is a cross-sectional view along the line A-A in FIG. 1;

FIG. 4 is an enlarged view of the cooling chamber identified in FIG. 1;

FIG. 5 is a cross-sectional view along the line B-B in FIG. 2;

FIG. 6 is a diagrammatic view of a vapour generating system according to a second embodiment of the present disclosure; and

FIG. 7 is a diagrammatic view of a vapour generating system according to a third embodiment of the present disclosure.

### DETAILED DESCRIPTION OF EMBODIMENTS

Embodiments of the present disclosure will now be described by way of example only and with reference to the accompanying drawings.

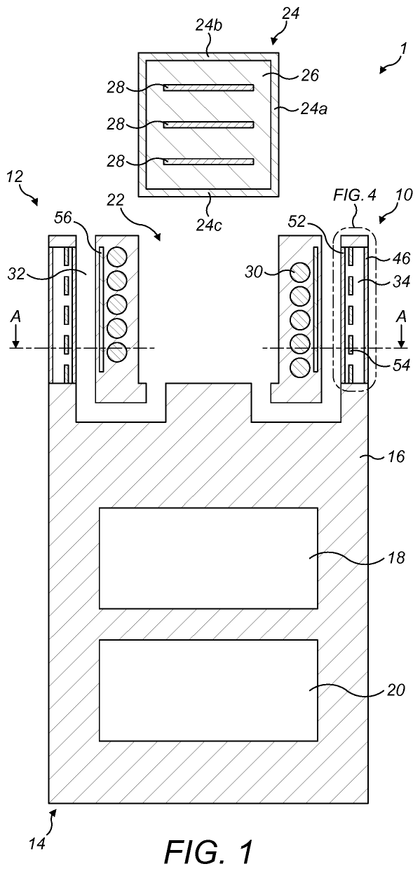

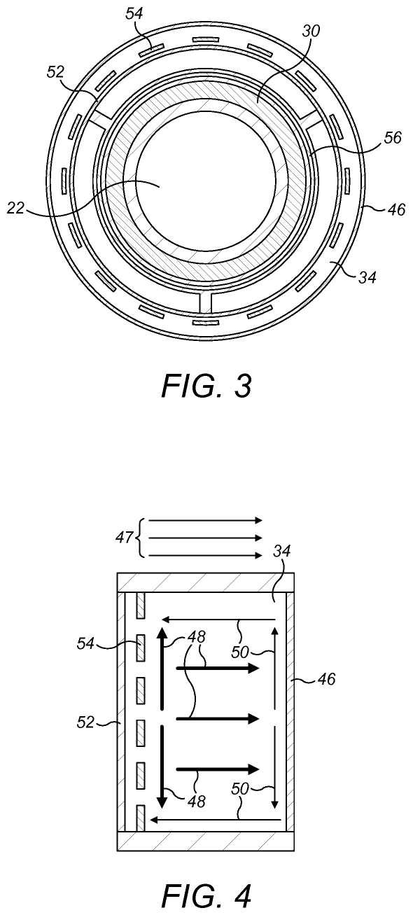

Referring initially to FIGS. 1 to 3, there is shown diagrammatically a first embodiment of a vapour generating system 1. The vapour generating system 1 comprises a vapour generating device 10 and a vapour generating article 24. The vapour generating device 10 has a proximal end 12 and a distal end 14 and comprises a device body 16 which includes a power source 18 and a controller 20 which may be configured to operate at high frequency. The power source 18 typically comprises one or more batteries which could, for example, be inductively rechargeable.

The vapour generating device 10 is generally cylindrical and comprises a generally cylindrical vapour generating space 22 formed as a cavity in the device body 16 at the proximal end 12 of the vapour generating device 10. The cylindrical vapour generating space 22 is arranged to receive a vapour generating material 26. In the illustrated embodiment, the cylindrical vapour generating space 22 is arranged to receive a correspondingly shaped generally cylindrical vapour generating article 24 containing the vapour generating material 26 and a heater in the form of one or more induction heatable susceptors 28. The vapour generating article 24 typically comprises a non-metallic cylindrical outer shell 24a and an air-permeable layer or membrane 24b, 24c at the proximal and distal ends to contain the vapour generating material 26 and allow air to flow through the vapour generating article 24. The vapour generating article 24 is a disposable article which may, for example, contain tobacco as the vapour generating material 26.

The vapour generating device 10 comprises a helical induction coil 30 which has a circular cross-section and which extends around the cylindrical vapour generating space 22. The induction coil 30 can be energised by the power source 18 and controller 20. The controller 20 includes, amongst other electronic components, an inverter which is arranged to convert a direct current from the power source 18 into an alternating high-frequency current for the induction coil 30.

The vapour generating device 10 includes an annular air flow passage 32 which surrounds the induction coil 30 and which is positioned between the induction coil 30 and a sealed annular cooling chamber 34. The annular air flow passage 32 communicates with the vapour generating space 22.

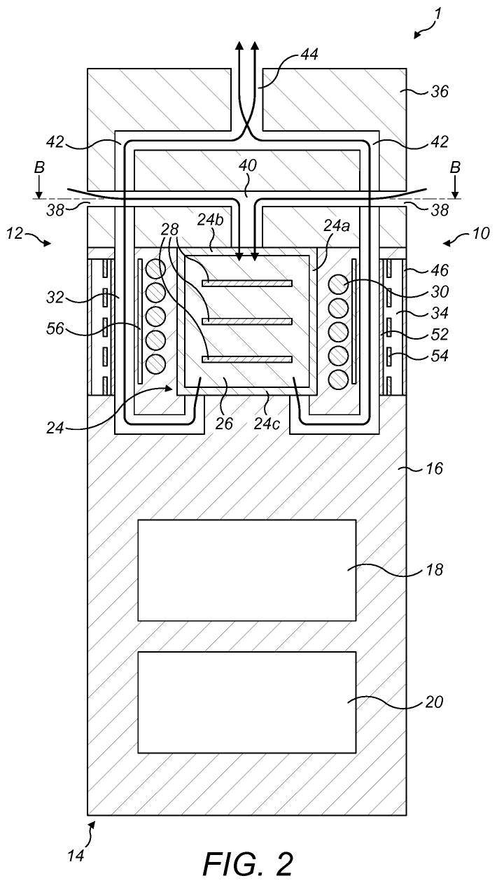

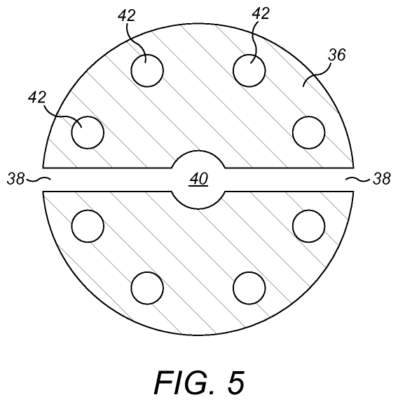

Referring to FIGS. 2 and 5, the vapour generating device 10 comprises a cover 36 which is removably mountable on the device body 16 at the proximal end 12. The cover 36 comprises radially extending air inlets 38 and a central air flow passage 40 which deliver air into the vapour generating space 22, and more particularly into the vapour generating article 24 through the air-permeable membrane 24b. The cover 32 also comprises a plurality of circumferentially spaced longitudinal air flow passages 42 which deliver a first vapour generated during use of the device 10 from the annular air flow passage 32 to an air outlet 44 where the first vapour can be inhaled by a user.

As will be understood by one of ordinary skill in the art, when the induction coil 30 is energised, an alternating and time-varying electromagnetic field is produced. This couples with the one or more induction heatable susceptors 28 and generates eddy currents and/or magnetic hysteresis losses in the one or more induction heatable susceptors 28 causing them to heat up. The heat is then transferred from the one or more induction heatable susceptors 28 to the vapour generating material 26, for example by conduction, radiation and convection.

The induction heatable susceptor(s) 28 can be in direct or indirect contact with the vapour generating material 26, such that when the susceptor(s) 28 is/are inductively heated by the induction coil 30, heat is transferred from the susceptor(s) 28 to the vapour generating material 26, to heat the vapour generating material 26 and thereby produce a first vapour. The vaporisation of the vapour generating material 26 is facilitated by the addition of air from the surrounding environment through the air inlets 38. The first vapour generated by heating the vapour generating material 26 exits the vapour generating space 22 through the annular air flow passage 32 and flows along the longitudinal air flow passages 42 to the air outlet 44 where it can be inhaled by a user of the device 10. The flow of air through the vapour generating space 22, i.e. from the air inlets 38, through the vapour generating space 22 and the annular air flow passage 32, and along the longitudinal air flow passages 42 in the cover 36 and out of the air outlet 44, can be aided by negative pressure created by a user drawing air from the air outlet 44 side of the device 10 and is shown diagrammatically by the arrows in FIG. 2.

Referring in particular to FIGS. 1, 3 and 4, the sealed annular cooling chamber 34 is positioned between the induction coil 30 and an outer surface 46 of the vapour generating device 10. The cooling chamber 34 comprises a liquid, such as water or ethyl-alcohol, which is vaporisable inside the cooling chamber 34 to form a second vapour and which is locked in the cooling chamber 34 both in its liquid and vapour form. More particularly, the liquid in the cooling chamber 34 absorbs heat, in particular through an inner wall 52 of the cooling chamber 34, from heated first vapour flowing through the annular air flow passage 32 and from other component parts of the device 10, such as the induction coil 30 and induction heatable susceptor(s) 28, thereby removing heat from the device 10 as shown diagrammatically by the arrows 47 in FIG. 4. In order to promote the absorption of heat by the liquid in the cooling chamber 34, the inner wall 52 typically comprises a material which has good thermal conduction properties, for example a metal such as copper.

As the liquid in the cooling chamber 34 absorbs heat and its temperature is raised above its boiling point, the liquid is vaporised (i.e. it evaporates) to form the second vapour. Heat is transferred from the second vapour to the surrounding ambient air via the outer surface 46 of the device 10 causing the second vapour to cool. As the second vapour cools, it condenses back into liquid form so that the liquid can again absorb heat from the heated first vapour and other component parts of the device 10. The transfer of heat from the second vapour takes place at a first position in the cooling chamber 34 which is proximate the outer surface 46 and the flow of the second vapour within the cooling chamber 34 is illustrated diagrammatically by the arrows 48. As the second vapour cools and condenses thereby returning to its liquid form, the liquid flows from the first position to a second position within the cooling chamber 34 which is proximate the inner wall 52, as illustrated diagrammatically by the arrows 50.

In order to promote the flow of the condensed liquid in the cooling chamber 34 from the first position proximate the outer surface 46 to the second position proximate the inner wall 52, the cooling chamber 34 comprises a cylindrical wick 54 which is positioned radially outwardly of the inner wall 52 and proximate to it. In some embodiments, the wick 54 comprises an electrically conductive copper mesh (schematically illustrated in the figures by means of the dashed line 54) and advantageously also acts as an electromagnetic shield for the induction coil 30. It should be noted that the inner wall 52 can also act as an electromagnetic shield for the induction coil 30, depending on the material from which it is fabricated. As mentioned above, the inner wall 52 may comprise copper which is an excellent material for electromagnetic shielding purposes as well as having excellent heat conductivity.

The vapour generating device 10 also comprises an electromagnetic shield layer 56 which is arranged outward of the induction coil 30, between the induction coil 30 and the wick 54. The shield layer 56 is formed of a ferrimagnetic, non-electrically conductive material such as ferrite, Nickel Zinc Ferrite or mu-metal. In the embodiment illustrated in FIGS. 1 and 2, the electromagnetic shield layer 56 comprises a substantially cylindrical sleeve, which is positioned radially outwardly of the helical induction coil 30 so as to extend circumferentially around the induction coil 30.

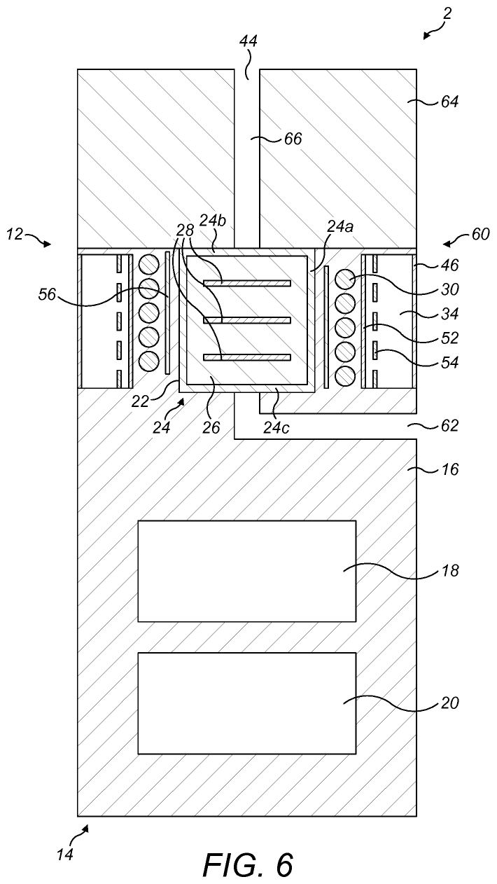

Referring now to FIG. 6, there is shown a second embodiment of a vapour generating system 2 which is similar to the vapour generating system 1 illustrated in FIGS. 1 to 5 and in which corresponding elements are designated using the same reference numerals.

The vapour generating system 2 comprises a vapour generating device 60 having an air inlet 62 which delivers air to the vapour generating space 22, and more particularly into the vapour generating article 24 through the air-permeable membrane 24c. The vapour generating device 60 further comprises a cover 64 which is removably mountable on the device body 16 at the proximal end 12. The cover 64 comprises an air flow passage 66 which delivers a first vapour generated during use of the device 60 from the vapour generating space 22 to an air outlet 44 where the first vapour can be inhaled by a user.

The vapour generating system 2 operates in the same manner as the vapour generating system 1 described above with reference to FIGS. 1 to 5 to heat the vapour generating material 26 and thereby generate a first vapour for inhalation by a user.

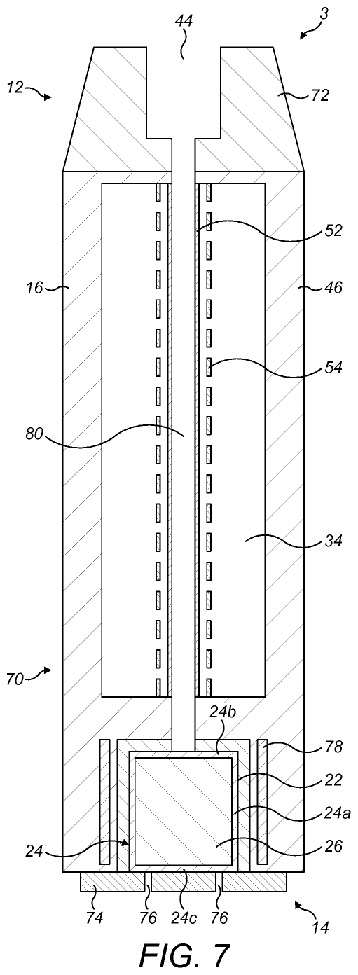

Referring now to FIG. 7, there is shown a third embodiment of a vapour generating system 3. The vapour generating system 3 has some features in common with the vapour generating systems 1, 2 described above with reference to FIGS. 1 to 6 and corresponding elements are designated using the same reference numerals.

The vapour generating system 3 comprises a vapour generating device 70 having an integrally formed mouthpiece 72 at the proximal end 12 of the device 70 and in which the cylindrical vapour generating space 22 is located at the distal end 14 of the device 70. A cover 74 for the vapour generating space 22 is removably mountable on the device body 16 at the distal end 14. The cover 74 includes air inlets 76 which allow air to flow into the vapour generating space 22.

The vapour generating space 22 is arranged to receive a vapour generating material 26. In the illustrated embodiment, the cylindrical vapour generating space 22 is arranged to receive a correspondingly shaped generally cylindrical vapour generating article 24 containing the vapour generating material 26. The vapour generating article 24 typically comprises a non-metallic cylindrical outer shell 24a and an air-permeable layer or membrane 24b, 24c at the proximal and distal ends to contain the vapour generating material 26 and allow air to flow through the vapour generating article 24. The vapour generating article 24 is a disposable article which may, for example, contain tobacco as the vapour generating material 26.

The vapour generating device 70 comprises a resistive heater 78, for example comprising a resistive heating element, which is positioned radially outwardly of the vapour generating space 22 and which extends around the vapour generating space 22.

During operation of the vapour generating system 3, an electric current is supplied to the resistive heater 78 causing it to heat up. The heat from the resistive heater 78 is transferred to the vapour generating material 26, for example by conduction, radiation and convection, to heat the vapour generating material 26 and thereby produce a first vapour. The vaporisation of the vapour generating material 26 is facilitated by the addition of air from the surrounding environment through the air inlets 76.

The first vapour generated by heating the vapour generating material 26 then exits the heating compartment 22 through the air-permeable layer 24b, flows along an air flow passage 80 and through the air outlet 44 where it is inhaled by a user of the device 70 through the mouthpiece 72. It will be understood that the flow of air through the vapour generating space 22 can be aided by negative pressure created by a user drawing air from the outlet side of the device 70 using the mouthpiece 72.

The vapour generating device 70 includes a sealed annular cooling chamber 34 which is positioned between the air flow passage 80 and the outer surface 46 of the vapour generating device 70. In the illustrated embodiment, the annular cooling chamber 34 extends longitudinally along substantially the whole of the length of the air flow passage 80, although it may extend along only a portion of the air flow passage 80 in other embodiments. As the heated first vapour flows along the air flow passage 80 during operation of the device 70, the liquid in the cooling chamber 34 absorbs heat from the first vapour through the inner wall 52, thereby cooling the first vapour in the manner described above with reference to FIGS. 1 to 6 and ensuring that the first vapour delivered via the air outlet 44 into the mouth of a user has optimum characteristics.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A vapour generating system comprising:
a vapour generating space for containing a vapour generating material;
a heater for heating the vapour generating material to generate a first vapour;
an air inlet, an air outlet and an air flow passage connecting the air inlet and the air outlet via the vapour generating space;
an outer surface; and
a cooling chamber comprising a liquid which is vaporisable to form a second vapour;
wherein the cooling chamber is positioned between the heater and the outer surface and/or between the air flow passage and the outer surface.

2. The vapour generating system according to claim 1, wherein the cooling chamber comprises a wick to transfer the liquid from a first position in the cooling chamber to a second position in the cooling chamber.

3. The vapour generating system according to claim 2, wherein the first position in the cooling chamber is closer to the outer surface than the second position in the cooling chamber.

4. The vapour generating system according to claim 1, wherein the liquid has a boiling point less than approximately 60° C., preferably less than approximately 50° C., preferably less than approximately 40° C.

5. The vapour generating system according to claim 2, wherein the wick comprises a mesh structure.

6. The vapour generating system according to claim 1, wherein the heater comprises an induction heatable susceptor and the vapour generating system comprises an induction coil arranged to generate an alternating electromagnetic field for inductively heating the induction heatable susceptor, the cooling chamber being positioned between the induction coil and the outer surface.

7. The vapour generating system according to claim 6, wherein the wick includes an electrically conductive material and is arranged to provide an electromagnetic shield for the induction coil.

8. The vapour generating system according to claim 6, wherein the wick extends substantially across at least one side of the induction coil.

9. The vapour generating system according to claim 6, further comprising a ferrimagnetic, non-electrically conductive material positioned between the wick and the induction coil and extending substantially across at least one side of the induction coil.

10. The vapour generating system according to claim 6, wherein the air flow passage is positioned between the induction coil and the outer surface.

11. The vapour generating system according to claim 6, wherein the cooling chamber comprises an inner wall proximate the induction coil, the inner wall including a metal having good heat conductivity and electromagnetic shielding properties.

12. The vapour generating system according to claim 1, wherein the cooling chamber is positioned between the outer surface and a portion of the air flow passage connecting the vapour generating space to the air outlet.

13. A vapour generating device comprising:
a vapour generating space for receiving a vapour generating material;
an induction coil for heating the vapour generating material to generate a first vapour;
an air inlet, an air outlet and an air flow passage connecting the air inlet and the air outlet via the vapour generating space;
an outer surface;
a cooling chamber comprising a liquid which is vaporisable to form a second vapour;
wherein the cooling chamber is positioned between the induction coil and the outer surface and/or between the air flow passage and the outer surface.

14. The vapour generating device according to claim 13, wherein the cooling chamber comprises a wick to transfer the liquid from a first position in the cooling chamber to a second position in the cooling chamber, the wick including an electrically conductive material and being arranged to provide an electromagnetic shield for the induction coil.

15. A vapour generating device comprising:
a vapour generating space for receiving a vapour generating material;
a resistive heater for heating the vapour generating material to generate a first vapour;
an air inlet, an air outlet and an air flow passage connecting the air inlet and the air outlet via the vapour generating space;
an outer surface;
a cooling chamber comprising a liquid which is vaporisable to form a second vapour;
wherein the cooling chamber is positioned between the resistive heater and the outer surface and/or between the air flow passage and the outer surface.
